(19) United States
(12) Patent Application Publication
(10) Pub. No.: US 2006/0178979 A1
(43) Pub. Date: Aug. 10, 2006

(54) Auction system and method for a life insurance secondary exchange

(75) Inventors: Ben Levine, Westlake Village, CA (US); Gary Wessely, Westlake Village, CA (US)

Correspondence Address: MCDERMOTT WILL & EMERY & LLP, Suite 3400, 2049 Century Park East, Los Angeles, CA, 90067, US

(73) Assignee: Life Advisors, Inc.

(21) Appl. No.: 11/054,663

(22) Filed: Feb. 8, 2005

(51) Int. Cl. G06Q 40/00; G06Q 99/00

(52) U.S. Cl. 705/37; 705/4; 705/80

(57) ABSTRACT

An auction-based system and method for a life insurance secondary exchange. Through a phased process that includes an information phase, a submission phase, an offer phase and a close phase, a life insurance policy may be submitted and sold by a policy holder to purchasing groups via a trusted advisor and broker. The policy information is received at a central location. Purchasing groups/providers are automatically notified when a policy is available for sale. If interested, the purchasing groups/providers pull further details on the policies they wish to review. The purchasing groups/providers then submit offers on the policies. The policy holder then determines whether an acceptable offer has been made, and sells the policy. If not, the policy may be efficiently re-auctioned.

### BACKGROUND OF THE INVENTION

1. Field of Invention

The present disclosure relates to financial services and, more particularly, to an Internet-based auction or exchange for a life insurance secondary marketplace.

2. Description of Related Art

The use of life insurance as an assignable asset has been on the rise for at least the last two decades. This is because circumstances may arise so that an individual may wish to sell his or her life insurance policy.

In a market known as the life settlement market, seniors may wish to sell their current policies when they already have sufficient funds to cover estate taxes or other fees and costs. Life insurance policies may have been purchased to cover these costs, but it may be decided later that the life insurance is not needed. The life settlement or senior settlement market has developed in relation to senior life insurance policies. This market is currently for insureds over the age of 65 with a minimum of two years' life expectancy and a maximum of fifteen years' life expectancy. A policy owner may no longer need a life insurance policy for other reasons. For example, a key person life insurance policy for an executive may no longer be needed when that executive leaves the company. Policy owners may also sell a policy because they can no longer afford the premiums. Another reason may be that the policy owner is able to purchase a policy or financial product that better suits their needs.

The main participants in the life settlement market may include policy owners and/or insureds, trusted advisors, life settlement brokers, purchasing groups and investor groups. The insureds in the life settlement market are generally seniors who are sixty-five years of age or older. The insured senior may also be the policy owner; however, life insurance policies are sometimes purchased by one individual or entity in order to ensure another. When the insured is a senior, the policy may be sold in the life settlement market. Trusted advisors generally represent the policy owner. Trusted advisors may include certified public accountants, accountants, bookkeepers, bankers, trust officers, financial planners, estate attorneys, trust attorneys, corporate attorneys, family law or divorce attorneys, life insurance agents and stock brokers.

Life settlement brokers, another participant in this process, are generally organizations that work with the trusted advisors to assist the policy owner in selling the policy in the secondary life insurance market. The brokers offer each policy for sale to various parties known as the purchasing groups/providers.

The life settlement process can be divided into four main process segments. Referring now to FIG. 1, illustrated is a simplified block diagram 100 of the life settlement process. The process is divided into the information phase 110, submission phase 120, offer phase 130 and close phase 140.

During the information phase 110, each policy must be prepared for presentation to each separate purchasing group/provider. The information includes signed HIPAA medical release forms from the insured, general policy and health information on the insured and medical records and policy in-force illustrations, just to name a few.

During the submission phase 120, the broker generally pushes the information on the policy to the purchasing groups/providers. This process is time-consuming and requires effort from the broker's perspective. During the offer phase 130, the broker determines whether any offers or acceptable offers are made. If a number of offers are made, the broker determines the best offer, and the offer is presented to the client for the close phase 140.

If no offer or no acceptable offer is made, the policy is sometimes re-submitted for review by the purchasing groups/providers. Again, if the broker determines whether any offers or acceptable offers are made, these offers or the best offer is relayed to the trusted advisor and client. If a number of offers are made, the broker determines the best offer, and the offer is presented to the client for the close phase 140.

As noted, where no offers or no acceptable offers are made, the settlement process loops back so that a policy is re-submitted to the purchasing groups/providers. This loop-back process may require substantial efforts on the broker's part. Alternatively, the broker could simply hold the policy until the insured advances in age.

Moreover, using the current process, an insurance policy must often be shopped to the purchasing groups/providers who may not be interested in the policy. It is only through the submission process that the purchasing groups/providers are made aware of the policy.

Most of the communications between the broker and purchasing groups/providers is faxed or e-mailed. Faxes and e-mails may be time-consuming and there is generally no central location for electronically maintaining them. Moreover, there are concerns regarding fraud protection and protection of the policy owner's sensitive information. Other concerns include the speed and accuracy of information used in determining a settlement.

There is a need for a life insurance settlement process that reduces the burdens on all those involved. There is a need for a more efficient way of handling life insurance settlements so that time and effort are not spent submitting to those purchasing groups/providers who are not interested in purchasing the policy. There is further a need for automation of the process between brokers and purchase groups/providers. There is also a need for a secure system that addresses fraud concerns and protection of the policy owner's sensitive information. More than one broker may list the same policy, thus resulting in confusion as to who actually represents the policy owner. For example, problems may be encountered when determining whom should be paid. Moreover, problems may be encountered in determining the proper representative with whom the sale should be negotiated.

### BRIEF SUMMARY OF INVENTION

The present disclosure addresses the needs noted above by providing an auction system and method for a life insurance secondary exchange. In accordance with one embodiment of the present disclosure, an auction system is provided for a life insurance secondary exchange.

The system comprises a memory system that includes life insurance policy information for at least one life insurance policy available for purchase, the memory system further including bidding requirements for the at least one life insurance policy, wherein the bidding requirements include terms and conditions for purchasing the policy; logic that submits at least part of the insurance policy information to at least one purchasing group, including logic that automatically notifies the at least one purchasing group of the availability of the at least one insurance policy for purchase; and logic that makes available, to the at least one purchasing group, insurance policy information related to the at least one policy; and wherein the insurance policy information includes a unique identification code associated with the insurance policy.

The system further includes logic that determines whether an offer acceptable to the policy owner was received for the at least one insurance policy; and if an acceptable offer was received, logic that closes the purchase of the at least one life insurance policy. Finally, the system includes at least one server that manages an auction process associated with the at least one life insurance policy.

In accordance with another embodiment of the present disclosure, a method is provided for a life insurance secondary exchange. The method comprises the steps of receiving life insurance policy information for at least one life insurance policy available for purchase, the information being received to at least one database associated with the life insurance secondary exchange. The method further comprises receiving submission of bidding requirements for the at least one life insurance policy, wherein the bidding requirements include terms and conditions for purchasing the policy, and wherein submission of the bidding requirements are received to the at least one database associated with the life insurance secondary exchange; and storing life insurance policy information and bidding requirements.

The method further comprises submitting at least part of the insurance policy information to at least one purchasing group, including automatically notifying the at least one purchasing group of the availability of the at least one insurance policy for purchase; and making available insurance policy information related to the at least one policy to the at least one purchasing group; and wherein the insurance policy information includes a unique identification code associated with the insurance policy. Finally, the method includes determining whether an offer acceptable to the policy owner was received for the at least one insurance policy; and if an acceptable offer was received, closing the purchase of the at least one life insurance policy.

In accordance with another embodiment of the present disclosure, computer-readable media is provided containing programming that, when executed on a computer processor, causes the processor to perform the steps of receiving life insurance policy information for at least one life insurance policy available for purchase, the information being received to at least one database associated with the life insurance secondary exchange. The computer program further contains programming that causes the processor to accept submission of bidding requirements for the at least one life insurance policy, wherein the bidding requirements include terms and conditions for purchasing the policy, and wherein submission of the bidding requirements are received to the at least one database associated with the life insurance secondary exchange; and storing life insurance policy information and bidding requirements.

The computer program further causes the processor to submit at least part of the insurance policy information to at least one purchasing group, including automatically notifying the at least one purchasing group of the availability of the at least one insurance policy for purchase; and making available insurance policy information related to the at least one policy to the at least one purchasing group; and wherein the insurance policy information includes a unique identification code associated with the insurance policy. Finally, the computer program causes the processor to perform the step of determining whether an offer acceptable to the policy owner was received for the at least one insurance policy; and if an acceptable offer was received, closing the purchase of the at least one life insurance policy.

These, as well as other objects, features and benefits will now become clear from a review of the following detailed description of illustrative embodiments and the accompanying drawings.

### BRIEF DESCRIPTION OF DRAWINGS

FIG. 1 is a simplified flow chart illustration of the life insurance settlement process.

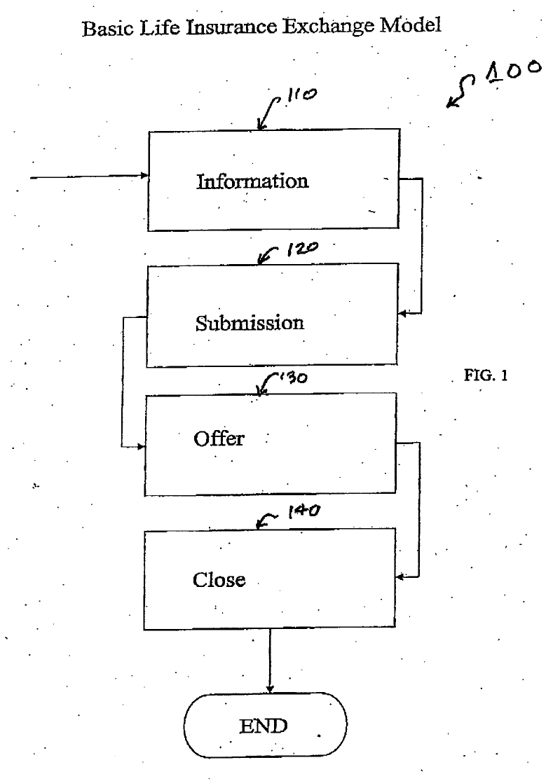

FIG. 2A illustrates a logical system architecture for a life insurance secondary exchange in accordance with one embodiment of the present disclosure.

FIG. 2B is a more detailed logical system architecture for the core application server in a life insurance secondary exchange in accordance with one embodiment of the present disclosure.

FIG. 3 illustrates a hardware architecture for the life insurance secondary exchange in accordance with one embodiment of the present disclosure.

FIG. 4A is a flow chart illustration of the information phase for an auction-based life insurance secondary exchange.

FIG. 4B is a flow chart illustration of the submission phase for an auction-based life insurance secondary exchange.

FIG. 4C is a flow chart illustration of the offer phase for an auction-based life insurance secondary exchange.

FIG. 4D is a flow chart illustration of the close phase for an auction-based life insurance secondary exchange.

### DETAILED DESCRIPTION OF ILLUSTRATIVE EMBODIMENTS

The present disclosure provides an auction-based method, computer program and system for a life insurance secondary exchange. Through a phased process that includes an information phase, a submission phase, an offer phase and a close phase, a life insurance policy may be submitted and sold by a policy owner to purchasing groups via a trusted advisor and/or broker.

The policy information is received at a central location or database. Purchasing groups/providers are automatically notified when a policy is available for sale. The purchasing groups may be notified by electronic message or other electronic means.

In addition to notification of available policies by electronic messaging, the auction-based system and method may include the display via the Internet of current available policies for purchase based on select qualities of the policy with regard to market standard, with a narrative description of the policy, and parameters set by the life settlement broker or trusted advisor for the purchase of the policy.

If interested, the purchasing groups pull further details on the policies they wish to review. The purchasing groups then submit offers on the policies. The policy holder then determines whether an acceptable offer has been made, and sells the policy. If not, the policy may be efficiently re-auctioned. Moreover, the close ratio is higher since the policy is only reviewed by those who are interested in the policy.

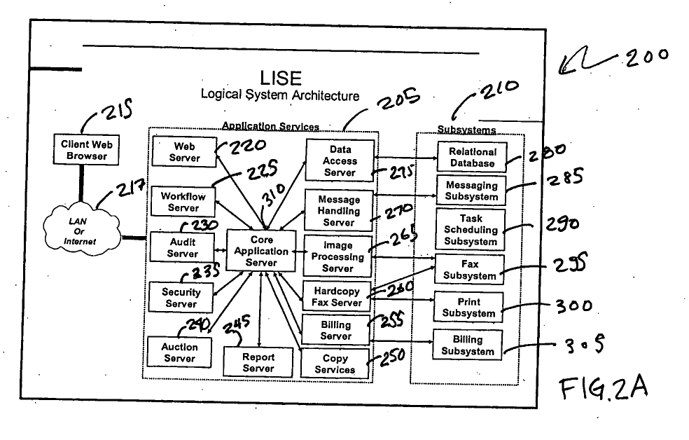

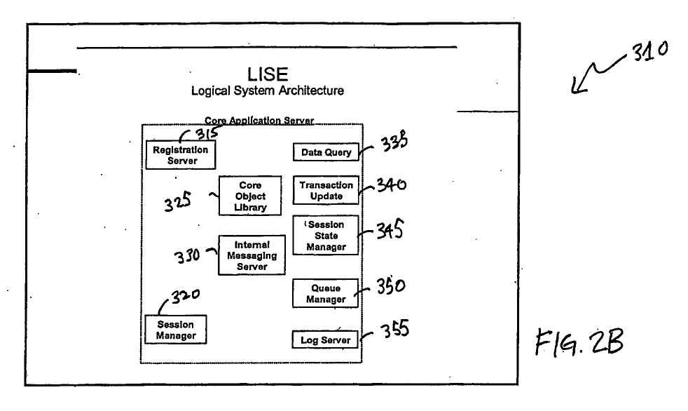

Referring now to FIG. 2A, illustrated is a logical system architecture 200 for an Internet-based auction exchange in accordance with one embodiment of the present disclosure. The system architecture includes application services 205 and associated subsystems 210, connected via a network 217 to a client web browser 215.

A user may access application services 205 via web browser 215 and a connection via network 217. The network 217 can be, for example, a local area network (LAN) or the Internet. The client screens connect to a series of application services 205, including servers and managers, which collectively provide all the logic to enable the system. The specific services invoked are determined by the particular action undertaken by the user.

Clients may be defined as any front-end applications, such as web browsers and forms, that interact with and access core system functions. The application servers 205 make up the core business logic enabling the overall system workflow and execution of embedded business logic. Data access servers 275 provide back-end access to data and information used by the application servers 205.

Information may flow through the system 200 by means other than user input. For example, information may flow via electronic messaging or image processing, including fax. Application services 205 reside on top of the operating system. All subsystems 210 are front-ended by dedicated application services 205. For example, the data is stored or retrieved in a relational database 280 in subsystem 210 via the data access server 275. Application services are transparent to the user.

Audit server 230 supports regulatory compliance in terms of confidentiality and auditing. Report server 245 provides support for ad-hoc reporting and trend analysis. Workflow server 225 facilitates workflow execution required to complete life settlement transactions by all involved parties. The workflow process is similar to an automated trading exchange. The elements of application services 205 may be described as an application server.

Elements of the application services 205 include those related to I/O functions which are supported by the web server 220, data access server 275, message handling server 270, image processing server 265, billing server 255, hardcopy fax server 260, copy services 250, and report server 245. Security functions are handled by security server 235 and audit server 230. Auction server 240 is also included for handling auction-related services. Hardcopy fax server 260 is used to receive faxes electronically and are not handled. Web server 220 handles web applications. Image processing server 265 handles documents that are scanned in to the exchange, e.g., .pdf, TIFF file, JPEG file. Billing server 255 pays the providers whether electronically or otherwise. Copy services 250 will copy medical records. Copies on a network can be copied to a file which can be handled by copy services. Report server 245 may allow the broker to perform research on the purchasing groups, e.g., billing, list of members, any search parameters on which a search may be based.

Other elements of subsystem 210 may include messaging subsystem 285 that supports messaging, task scheduling subsystem 290 that supports batch scheduling of various system-related tasks, fax subsystem 295 that supports fax transmittals, print subsystem 300 and billing subsystem 305. Subsystem 210, typically provided by the operating system, support system functionality by providing services for various standardized tasks.

Referring now to FIG. 2B, illustrated is a more detailed logical system architecture for a core application server in accordance with one embodiment of the present disclosure. The core application server 310 is the central part of application services. The core application server 310 includes the core business logic central to processing life settlement transactions. The core application server 310 is composed of multiple services, some directly related to business processing, others to support business processing. The core business object or core object library object that is central to the life settlement process is programmed into the core application server 310 in order to implement and/or assist in implementing the methods disclosed herein.

The system architecture may be based on object-oriented software principles that result in a scalable, extensible and portable software architecture.

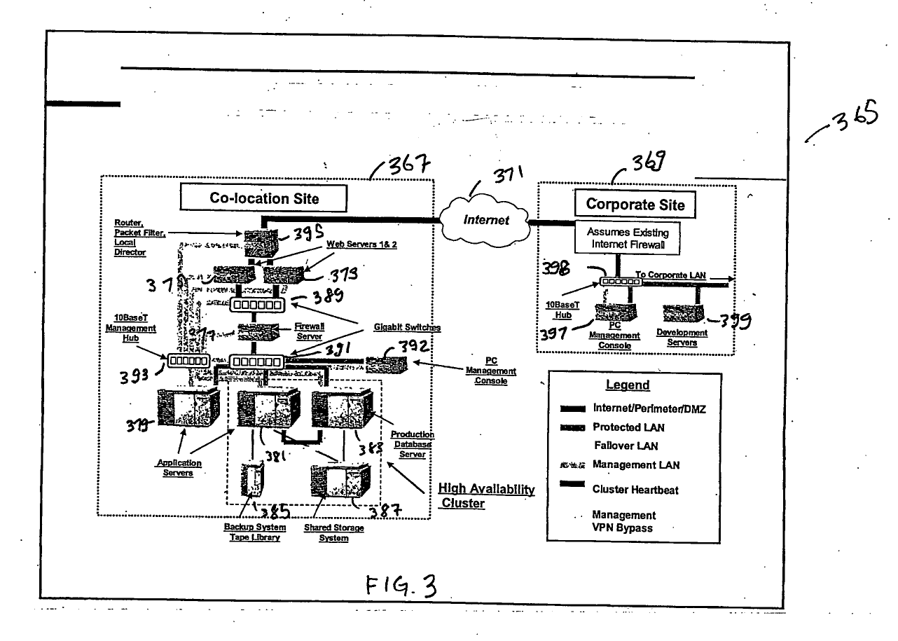

FIG. 3 illustrates a hardware architecture for production and development environments in a life insurance secondary exchange. The hardware configuration includes a co-location site 367 connected via a network 371 such as the Internet to corporate site 369.

The hardware design includes multiple servers widely available. At the co-location site 367, the servers include web servers 373, 375, application servers 379, 381, production database server 383 and firewall server 377. These servers are clustered, thereby allowing redundant servers to take over in case of failure by a primary server. Clustering software is configured to detect failover scenarios and redirect software-based services as required.

The web servers 373, 375 are connected to a router, packet filter, local director 395. At the other end, web servers are connected via gigabit switch 389 to firewall server 377. Gigabit switch 391 connects application server 379 and PC management console 392 to a cluster. The cluster includes application servers 381, 383. Redundant networks are supplied in case of primary LAN failure. Redundant networks also increase the overall throughput of LAN traffic through the system. A 10baseT management hub 393 provides connections for the devices throughout the co-location site 367.

Storage at co-location site 367 is shared storage 387 connected to multiple servers. This connection may be made over multiple redundant, fiber channel connections. Shared storage facilitates high availability of the auction-based system and increases the flexibility by which storage is managed and partitioned for use by multiple servers. The system is being constantly backed up with a tape back up 385.

Corporate site 369 serves as a separate management LAN that allows system administrators to monitor and configure servers in a secure fashion. Management may be done via a local management station or by secure, remote access over a virtual private network. Corporate site 369 includes a PC management console 397, development servers 399 which may be operably connected via 10baseT hub 398 to network 371. Network 371, in turn, connects corporate site 369 to co-location site 367.

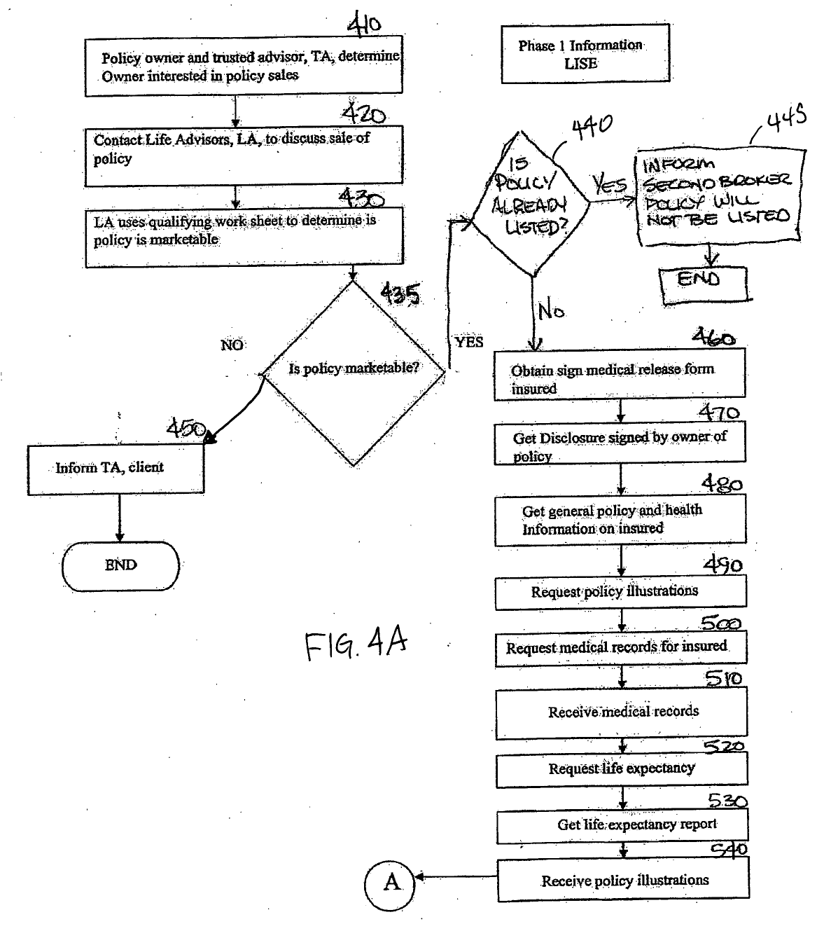

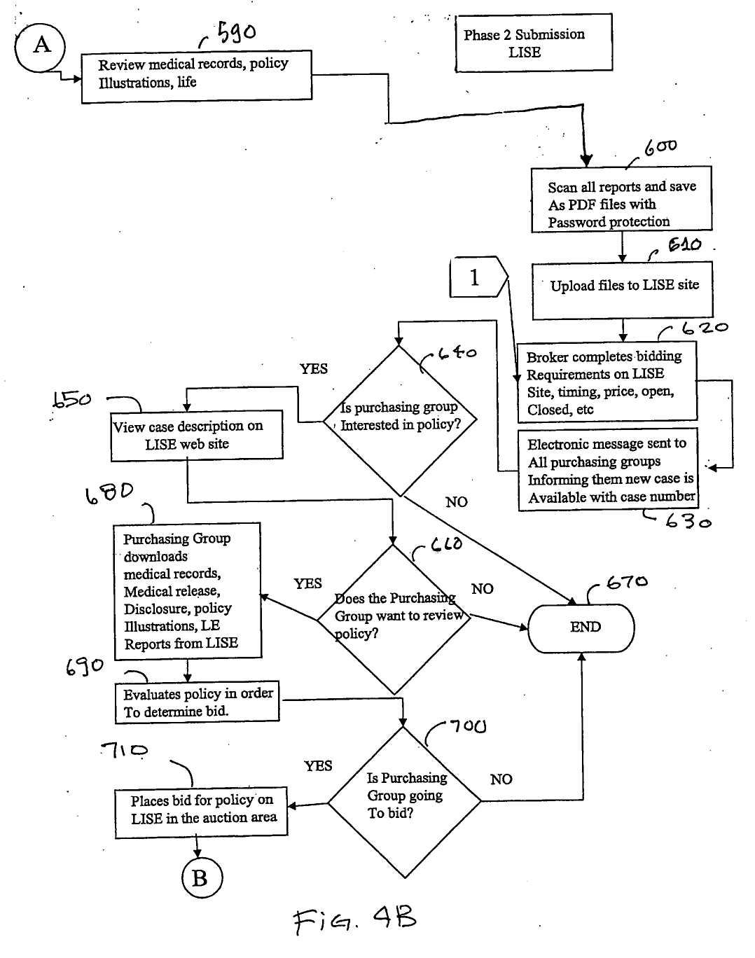

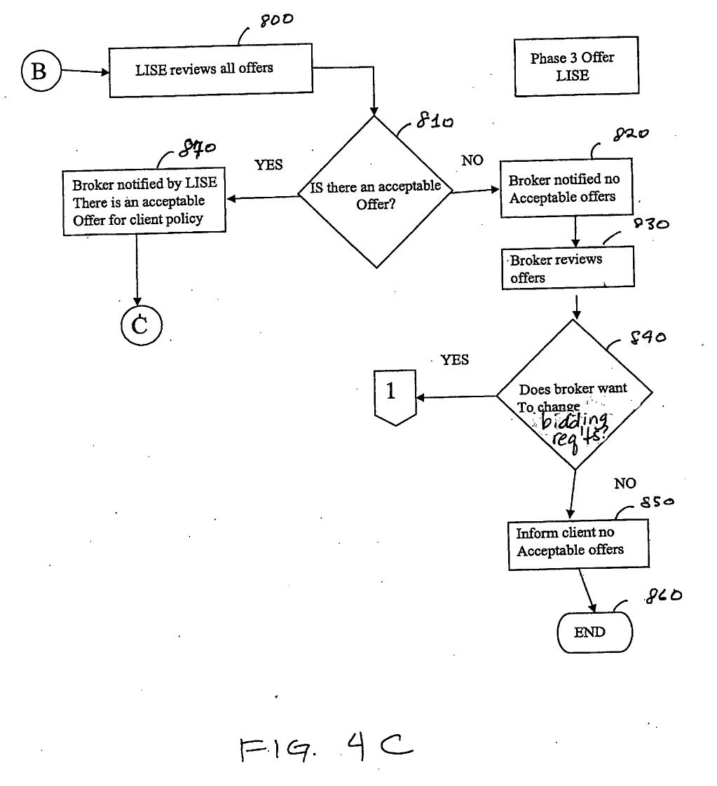

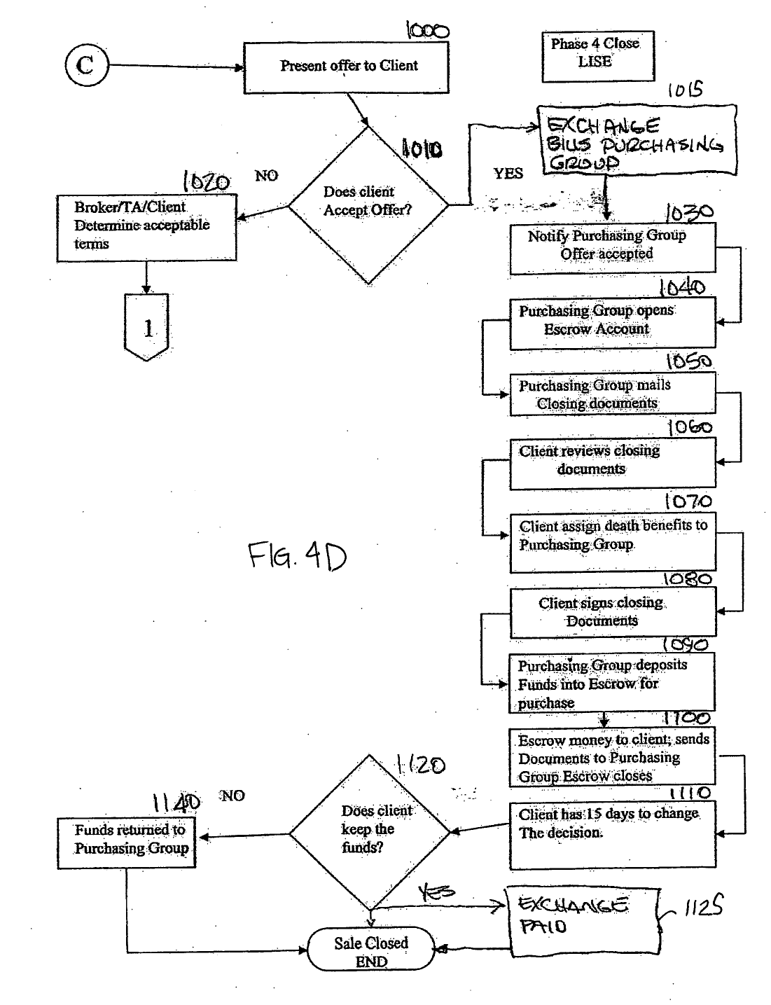

The auction-based method for a life insurance secondary exchange may be described in accordance with various flow charts as described in connection with FIGS. 4A-4D. One or more parts of the method may be implemented in software.

FIG. 4A is a flow chart illustration of the information phase 400 for an auction-based life insurance secondary exchange. In accordance with FIG. 4A, information is gathered pertaining to the insurance policy and insured. At step 410, the policy owner and trusted advisor determine that the owner is interested in a policy sale. At step 420, the auction exchange owner is contacted regarding the sale of the policy. At steps 430 and 435, the auction exchange uses a qualifying worksheet to make a preliminary determination as to whether the policy is marketable. In some instances, the purchasing group may wish to sell a policy or even a portfolio of policies. In this case, the purchasing group may become a broker or a trusted advisor. At step 440, the system determines whether the policy is already listed. If the policy is already listed, at step 445, the system informs the broker that the second policy will not be listed. This eliminates double-brokering because one and only one broker is listed on the system for each policy. This also eliminates confusion as to who is representing the policy owner.

If the policy does not meet marketability requirements, at step 450, the trusted advisor or life settlement broker and client are informed as such by the exchange.

If it is determined that the policy is marketable, at step 460, the trusted advisor or broker obtains from the insured a signed medical release form that conforms to relevant standards. A disclosure is signed by the policy owner at step 470. The trusted advisor may also obtain other information such as general policy, personal and medical information at step 480.

With the information that was obtained from the policy owner, the trusted advisor or life settlement broker obtains illustrations for the in-force policy based on purchasing group requirements at step 490. The trusted advisor or life settlement broker also requests medical records for the insured at step 500, and receives those records at step 510. Often, a life expectancy report must follow medical records because medical records are needed in order to make a determination as to life expectancy.

A request for life expectancy evaluation may be made at step 520 when request documents are faxed to one or more actuarial firms. This evaluation may be performed without a medical examination since the insured's medical records are faxed or sent by other electronic means, such as e-mail, to the actuarial firm. The exchange requests evaluation reports at step 520 and the exchange receives life expectancy reports at step 530.

A life expectancy report is received at step 530 after it has been determined by one or more actuarial firms. (Later, when the policy is submitted to purchasing groups, if the life expectancy is within the bounds of the purchasing group's requirements, the purchasing groups evaluate the cost of maintaining the policy until the death benefit can be collected. A return on investment may be calculated using this cost and the death benefit. If the return on investment is acceptable, an offer to purchase the policy may be made.) Policy illustrations may be received at step 540.

The policy is now prepared for the second phase of the life settlement process, which may be described as the submission phase. Referring now to FIG. 4B illustrated is a flow chart of the submission phase for an auction-based life insurance secondary exchange. The life insurance secondary exchange of the present disclosure permits all participants in the life insurance settlement process to enjoy advantages. For example, the submission phase is automated and fewer faxes are sent between the broker and the purchasing groups. Moreover, instead of the push policy that may be present in some systems, the system of the present disclosure includes a centralized automated way for the brokers and purchasing groups to communicate with purchasing groups pulling the information needed.

First, the information gathered at the information phase is scanned electronically in preparation for use on the auction exchange. At step 600 of FIG. 4B, steps are taken to prepare electronic versions of the records and other information retrieved at the earlier information stage. Reports are scanned and saved as viewable files. At step 610, these files are uploaded to the auction exchange.

At step 620, the broker completes applicable bidding requirements on the auction exchange web site. These requirements may include timing, including the point when bidding is open and when it is closed. The bidding requirements may also include the price. Any other bidding requirements desired may be associated with the policy. The bidding requirements may indicate that the auction process is a time-bound process in which purchasing groups bid for life insurance policies and the purchasing group with the highest bid during the time specified wins the right to purchase the policy. The bidding requirements may also indicate that the auction process is a non-time bound process in which parties contract and negotiate for the selling price of the policy and reach an agreed upon price for the policy.

At step 630, an electronic message or telephonic message is sent to all purchasing groups. These purchasing groups may be pre-qualified by the exchange, including by determining whether sufficient funds are available to purchase the policy and by ensuring that they comply with applicable confidentiality requirements related to the policy information. If a state license is required in order for the policy to be purchased, the exchange may verify that such a license is present. If electronic notification is performed, the electronic message informs the purchasing groups a new case is available with a case number and/or unique identification code for the policy. At step 640, the auction exchange determines whether a purchasing group is interested in the policy. If not, the submission process ends at step 670. If, on the other hand, a purchasing group is interested in the policy, then the auction exchange makes a case description available in an accessible location, e.g., a web site. The auction exchange then determines at 660 whether the purchasing group wants to review the policy. If the purchasing group wishes to review the policy, then the auction exchange permits the purchasing group to download medical records, pertinent medical release disclosures, policy illustrations, a life expectancy report and other information deemed pertinent to the auction exchange.

At step 690, the purchasing group evaluates the policy to determine the bid. The purchasing group determines the bid at step 700, and places a bid for the policy at step 710. If no, then the process moves to 670 and ends.

The life settlement process then moves to the offer phase. The auction exchange may review all offers for the insurance policy at step 800. Of course, numerous auctions could take place at the auction exchange simultaneously. Accordingly, each of these various auctions could be in various disparate phases at any given point.

Referring now to FIG. 4C, shown is a flow chart illustration of the offer phase for an auction-based life insurance secondary exchange. The auction exchange may then determine at step 810 whether an acceptable offer exists for the life insurance policy at issue. If no acceptable offers exist, the broker may be notified of this fact at step 820.

The broker may then review all offers at step 830. The auction exchange gives the broker an opportunity to change the terms of the bidding requirements at step 840. If it is determined at step 840 that the broker does not wish to change the terms of the offer, the client may be informed at step 850 that no acceptable offers are available for the policy. The offer phase may then end.

If, at step 810, it is determined that there is an acceptable offer for the policy, the life settlement process may enter the close phase. Referring now to FIG. 4D, shown is a flow chart illustration of the close phase for an auction-based life insurance secondary exchange. The offer may be presented to the client at step 1000. If the client accepts the offer at step 1010.

If the broker wishes to change the terms of the bidding requirements at step 840, then the broker, trusted advisor and client determine acceptable terms for the offer. If the client accepts the offer after the change of terms to new acceptable terms, the auction exchange determines whether the client accepts the offer at step 1010.

If the client accepts the offer at step 1010, whether as a result of the change in terms or the result of an offer made based on the original terms, the purchasing group is notified at step 1030 that the offer is accepted. In 1015, the exchange bills the purchasing group. The exchange would invoice the purchasing group or buyer, or the purchasing group could be included as part of the escrow fees. It is possible that all purchasing groups may be billed if they use the life expectancy report. The purchasing group opens an escrow account at step 1040, and the purchasing group sends the closing documents electronically at step 1050. The client reviews the closing documents at step 1060, and assigns death benefits to the purchasing group at step 1070. The client signs closing documents at step 1080.

The purchasing group deposits funds into escrow for the purchase at step 1090. The escrow money is sent to the policy owner at step 1100 and other closing documents are sent to the escrow group. Once escrow closes, the policy owner may have a waiting period to change his or her mind at step 1110. The auction exchange determines whether the policy owner keeps the funds at step 1120. If the policy owner keeps the funds, the sale closes at step 1130. If the auction exchange determines that the client is not to keep the funds at step 1120, the funds are returned to the purchasing group at step 1140. At 1125, the exchange is paid. If the policy owner changes their mind, then the funds cannot be kept by the policy owner. If the policy owner does not change its mind, they may keep the funds.

The auction-based method and system may also include an on-line feature where both life settlement brokers and purchasing groups can obtain historical information based on previous life settlement transactions. The auction-based system and method may also provide for storage of the life insurance policies, medical records and unique policy information that have not been sold, but might be eligible for sale at a later date. Providing historical information and storage of the policy information facilitates re-auctioning of the policy.

The medical information, policy information and other information related to the insured and/or policy owner can also be used to purchase new life insurance policies.

The auction-based system and method described herein may provide benefits to all parties involved, including the senior clients, the trusted advisors, the life settlement brokers and purchasing groups. The senior clients could benefit by having maximum exposure for their policies in a competitive environment in order to ensure the best price for the policy. The system and method of the present disclosure may assist in giving the senior clients confidence in a self-regulated environment in which personal information can be exchanged. The auction-based system and method may further provide senior clients trust because all parties involved sign a code of ethical conduct that can be enforced, and the seniors may also feel secure in knowing that only the information needed is provided. The exchange provides a safe and secure selling environment. Moreover, privacy is maintained since personal information is obtained by purchasing groups that are interested in purchasing the policy.

The trusted advisors may experience benefits from this system in that they can be confident that this auction-based system and method will provide their clients with the best price for the policy. The trusted advisors may also feel secure in knowing client information is protected and that all partners have signed a code of ethical conduct and agreed to a compensation structure. The exchange provides easy access to the secondary life insurance market. It establishes a safe, secure and professional environment. It is also a potential source of income for the trusted advisors.

The life settlement brokers can have confidence in representing their trusted advisor's clients that will give the client the best price for the policy. Expense associated with brokering life insurance policies may be minimized while exposure is maximized. Moreover, all competitors are using similar rules in participating in the policy sale. Brokers are able to control the selling environment. Brokers are also provided with flexible selling options to meet the selling requirements. No double-brokering occurs because only one broker is permitted to list a single policy. The brokers have access to comparable previous transactions via historical information.

Purchasing groups can have confidence in knowing that they can view a large number of insurance polices on the exchange. Moreover, concerns regarding fraud and double-brokering may be reduced. Purchasers now have immediate access to policies that they would not be otherwise able to access. The exchange brings qualified buyers and sellers together. Purchasers are able to perform a more targeted search for policies that fit specific parameters. This is important because they can build portfolios of policies and sell bonds against that portfolio. Ratings companies have specific guidelines for these policies. Using the exchange, purchasing groups can more easily build conforming portfolios.

While the specification describes particular embodiments of the present invention, those of ordinary skill can devise variations of the present disclosure without departing from the inventive concept.

It should also be understood that, while the embodiments are described in terms of life insurance policies, the insurance policy could be any other type of insurance policy that can be sold by one party to another.

We claim:

1. A computer-based auction method for a life insurance secondary exchange, the method comprising the steps of:
receiving life insurance policy information for at least one life insurance policy available for purchase, the information being received to at least one database associated with the life insurance secondary exchange;
receiving submission of bidding requirements for the at least one life insurance policy, wherein the bidding requirements include terms and conditions for purchasing the policy, and wherein submission of the bidding requirements are received to the at least one database associated with the life insurance secondary exchange;
storing the life insurance policy information and bidding requirements;
submitting at least part of the insurance policy information to at least one purchasing group, including:
automatically notifying the at least one purchasing group of the availability of the at least one insurance policy for purchase; and
making available insurance policy information related to the at least one policy to the at least one purchasing group; and
wherein the insurance policy information includes a unique identification code associated with the insurance policy;
determining whether an offer acceptable to the policy owner was received for the at least one insurance policy; and if an acceptable offer was received, closing the purchase of the at least one life insurance policy.

2. The method of claim 1, wherein the step of closing the purchase of at least one life insurance policy includes the steps of:
electronically delivering the closing documents from the at least one purchasing group to the policy owner.

3. The method of claim 1, wherein the step of automatically notifying the at least one purchasing group of the availability of the at least one insurance policy for purchase, includes the step of:
sending an electronic message to the at least one purchasing group.

4. The method of claim 1, further comprising:
making available historical information to life settlement brokers and purchasing groups based on previous settlement transactions.

5. The method of claim 1, wherein the insurance policy information includes medical records, general policy information on the insured, and the life expectancy of the insured.

6. The method of claim 1, further comprising:
after determining that no acceptable offer was received for the at least one life insurance policy, receiving submission of changed bidding requirements for the at least one life insurance policy, wherein the changed bidding requirements include different terms and conditions for purchasing the policy, and wherein submission of the changed bidding requirements is received to the at least one database associated with the life insurance secondary exchange;
submitting at least part of the insurance policy information to at least one purchasing group, including:
automatically notifying the at least one purchasing group of the availability of the at least one insurance policy for purchase; and
making available, to the at least one purchase group, insurance policy information related to the at least one policy, the information including changed bidding requirements;
determining whether an offer acceptable to the policy owner was received for the at least one insurance policy; and if an acceptable offer was received, closing the purchase of the at least one life insurance policy.

7. The method of claim 1, wherein multiple insurance policies are available for purchase in accordance with a single set of bidding requirements.

8. The method of claim 1, further comprising the step of:
prior to the step of submitting at least part of the insurance policy information to at least one purchasing group, determining whether the policy is marketable.

9. The method of claim 1, further comprising the step of:
determining whether the at least one purchasing group is pre-qualified, including by determining compliance with confidentiality requirements for the life insurance policy information.

10. Computer-readable media containing programming that, when executed on a computer processor, causes the processor to perform the steps of:
receiving life insurance policy information for at least one life insurance policy available for purchase, the information being received to at least one database associated with the life insurance secondary exchange;
receiving submission of bidding requirements for the at least one life insurance policy, wherein the bidding requirements include terms and conditions for purchasing the policy, and wherein submission of the bidding requirements are received to the at least one database associated with the life insurance secondary exchange;
storing the life insurance policy information and bidding requirements;
submitting at least part of the insurance policy information to at least one purchasing group, including:
automatically notifying the at least one purchasing group of the availability of the at least one insurance policy for purchase; and
making available insurance policy information related to the at least one policy to the at least one purchasing group; and
wherein the insurance policy information includes a unique identification code associated with the insurance policy;
determining whether an offer acceptable to the policy owner was received for the at least one insurance policy; and if an acceptable offer was received, closing the purchase of the at least one life insurance policy.

11. The computer program of claim 10, wherein the step of closing the purchase of at least one life insurance policy includes the steps of:
electronically delivering the closing documents from the at least one purchasing group to the policy owner.

12. The computer program of claim 10, wherein the step of automatically notifying the at least one purchasing group of the availability of the at least one insurance policy for purchase, includes the step of:
sending an electronic message to the at least one purchasing group.

13. The method of claim 10, further comprising:
making available historical information to life settlement brokers and purchasing groups based on previous settlement transactions.

14. The computer program of claim 10, wherein the insurance policy information includes medical records, general policy information on the insured, and the life expectancy of the insured.

15. The computer program of claim 10, further comprising:
after determining that no acceptable offer was received for the at least one life insurance policy, receiving submission of changed bidding requirements for the at least one life insurance policy, wherein the changed bidding requirements include different terms and conditions for purchasing the policy, and wherein submission of the changed bidding requirements is received to the at least one database associated with the life insurance secondary exchange;
submitting at least part of the insurance policy information to at least one purchasing group, including:
automatically notifying the at least one purchasing group of the availability of the at least one insurance policy for purchase; and
making available, to the at least one purchase group, insurance policy information related to the at least one policy, the information including changed bidding requirements;
determining whether an offer acceptable to the policy owner was received for the at least one insurance policy; and if an acceptable offer was received, closing the purchase of the at least one life insurance policy.

16. The computer program of claim 10, wherein multiple insurance policies are available for purchase in accordance with a single set of bidding requirements.

17. The computer program of claim 10, further comprising:
prior to the step of submitting at least part of the insurance policy information to at least one purchasing group, determining whether the policy is marketable.

18. The computer program of claim 10, further comprising:
determining whether the at least one purchasing group is pre-qualified, including by determining compliance with confidentiality requirements for the life insurance policy information.

19. An auction-based system for a life insurance secondary exchange, the system comprising:
a memory system that includes life insurance policy information for at least one life insurance policy available for purchase, the memory system further including bidding requirements for the at least one life insurance policy, wherein the bidding requirements include terms and conditions for purchasing the policy;
logic that submits at least part of the insurance policy information to at least one purchasing group, including:
logic that automatically notifies the at least one purchasing group of the availability of the at least one insurance policy for purchase; and
logic that makes available insurance policy information related to the at least one policy to the at least one purchasing group; and
wherein the insurance policy information includes a unique identification code associated with the insurance policy;
logic that determines whether an offer acceptable to the policy owner was received for the at least one insurance policy; and logic that closes the purchase of the at least one life insurance policy if an acceptable offer was received,
at least one server that manages an auction process associated with the at least one life insurance policy.

20. The system of claim 19, wherein the logic that closes the purchase of at least one life insurance policy includes logic that electronically delivers the closing documents from the at least one purchasing group to the policy owner.

21. The system of claim 19, wherein the logic that automatically notifies the at least one purchasing group of the availability of the at least one insurance policy for purchase, includes logic that sends an electronic message to the at least one purchasing group.

22. The system of claim 19, further comprising:
logic that makes available historical information to life settlement brokers and purchasing groups based on previous settlement transactions.

23. The system of claim 19, wherein the insurance policy information includes medical records, general policy information on the insured, and the life expectancy of the insured.

24. The system of claim 19, further comprising:
logic that determines that no acceptable offer was received for the at least one life insurance policy, and logic that receives submission of changed bidding requirements for the at least one life insurance policy, wherein the changed bidding requirements include different terms and conditions for purchasing the policy, and wherein submission of the changed bidding requirements is received to the at least one database associated with the life insurance secondary exchange;
logic that submits at least part of the insurance policy information to at least one purchasing group, including:
logic that automatically notifies the at least one purchasing group of the availability of the at least one insurance policy for purchase; and
logic that makes available, to the at least one purchase group, insurance policy information related to the at least one policy, the information including changed bidding requirements;
logic that determines whether an offer acceptable to the policy owner was received for the at least one insurance policy; and logic that closes the purchase of the at least one life insurance policy if an acceptable offer was received.
